(19) United States
(12) Patent Application Publication
(10) Pub. No.: US 2020/0092678 A1
(43) Pub. Date: Mar. 19, 2020

(54) METHOD AND APPARTUS FOR ENTITY CHECKIN-IN AND TRACKING

(71) Applicant: SAFE SUBS, LLC, Howell, MI (US)

(72) Inventors: Christopher J. PAGETT, Howell, MI (US); Christopher J. ROSS, Spring, TX (US)

(21) Appl. No.: 16/130,220

(22) Filed: Sep. 13, 2018

(51) Int. Cl. H04W 4/029; H04W 4/021; H04L 29/08; G06F 17/30

(52) U.S. Cl. CPC H04W 4/029; G06F 17/30997; H04L 67/306; H04W 4/021

(57) ABSTRACT

A system includes a processor configured to receive a check-in request from a requestor. The processor is further configured to determine a group to which the requestor belongs, responsive to the request. The processor is also configured to display check-in candidates designated to the group. Further, the processor is configured to receive selection of a check-in candidate and create an association between the check-in candidate and a requestor-location responsive to the selection.

### TECHNICAL FIELD

The illustrative embodiments generally relate to methods and apparatuses for entity check-in and tracking.

### BACKGROUND

Parents are understandably protective of their children, but they also want to give those children the freedom to engage in play with other children. Commonly, this involves play with others in the same neighborhood, and children often drift from one house to another while playing.

While it is nice for children to be able to move around freely, parents still would like to know where those children are located. There are many opportunities for tracking children, including the use of cellular and other wireless devices, which often have self-reporting and/or tracking features. Unfortunately, because children are typically more interested in play than in reporting where they are, these devices can be left behind or lost by the children to whom they are assigned. The devices also suffer from power shortages when not fully charged, and are often expensive and easily broken, and thus not always appropriate for children of a certain age.

Parents may be able to call other parents when children are at their house, but this requires knowledge of each child's parents phone number, or reliance on the child to know the number, and further requires the effort of calling each parent. In a world of address books and contact lists, many people, even children, may not even know more than one or two phone numbers.

Accordingly, there are few, if any, good solutions for tracking children that do not rely on the children to proactively and intentionally report in some manner. Further, with food allergies and dietary constraints, there are secondary issues of which the children themselves may be limitedly aware. And, finally, if a parent wants a child to come home, the parent must either call that child's phone (relying on the phone being charged and possessed) and/or call the people at whose house the child is playing. Again, this requires knowledge of both the child's location and the phone number corresponding to that location.

### SUMMARY

In a first illustrative embodiment a system includes a processor configured to receive a check-in request. The processor is also configured to, responsive to the request, determine a group to which a requestor, identified as having originated the request, belongs. The processor is further configured to identify check-in candidates predesignated to the group, receive selection of a check-in candidate, and create an association between the check-in candidate and a requestor-location responsive to the selection.

In a second illustrative embodiment, a computer-implemented method includes instructing creation of a time-stamped record of a child being located at a requestor-location, included with a request and responsive to the request. The method also includes notifying a requestor, who originated the request, of any predefined alerts associated with the child, and notifying a predefined guardian of the child of the requestor-location and time-stamp, both as a result of the request.

In a third illustrative embodiment, a computer-implemented method includes identifying a list of children, predesignated as belonging to a group to which a guardian-requestor, who originated a request, is a member, responsive to the check-in request. The method also includes, responsive to selection of one or more of the children, creating an association between the selected children and a predefined guardian-requestor location, including notifying the guardian-requestor of any predefined alerts associated with any of the children and notifying predefined guardians of the selected children of the guardian-requestor location being associated with the respective selected children with whom individuals of the predefined guardians share a predefined relationship.

### BRIEF DESCRIPTION OF THE DRAWINGS

FIG. 1 shows an illustrative system for managing a set of neighborhood and play area groups;

FIG. 2 shows an illustrative process for joining a neighborhood or group;

FIG. 3 shows an illustrative check-in process;

FIG. 4 shows an illustrative check-in completion process;

FIG. 5 shows an illustrative notification/communication process; and

FIG. 6 shows an illustrative play-group connection process.

### DETAILED DESCRIPTION

As required, detailed embodiments are disclosed herein; however, it is to be understood that the disclosed embodiments are merely illustrative and may be incorporated in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

In addition to having exemplary processes executed by a cloud computing system located in the cloud, in certain embodiments, the exemplary processes may be executed by a computing system in communication with the cloud. Such a system may include, but is not limited to, a wireless device (e.g., and without limitation, a mobile phone) or a remote computing system (e.g., and without limitation, a server) connected through the wireless device.

In certain embodiments, particular components of a connected system may perform particular portions of a process depending on the particular implementation of the system. By way of example and not limitation, if a process has a step of sending or receiving information with a wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

Before the era of wireless devices, parents would often call other parents when children were at their house. Or, alternatively, children would simply tell their parents where they were going and the parent would assume that they were at the specified destination.

Now, in the digital era of smartphones and wearables, many children are provided with a phone or smart device, so parents can keep track. These devices, while useful, can suffer from a variety of problems including, but not limited to, power loss, loss of signal, breakage, loss, etc. Many young children still do not have such devices, and thus parents must still rely on traditional phone calls or pre-planning to know where their children are located.

Parents would prefer a system that allowed them to be more watchful of their children, but which still interfered in their children's lives in a limited manner, and which did not rely on the child self-reporting or carrying a particular device. The illustrative embodiments provide improved methodologies for keeping track of children (or other entities) in a manner that places limited impact on other parents. The embodiments provide connection, communication, tracking and updating as some of their solutions, allowing children to more freely roam the neighborhood while not being out or range of the watchful eyes of their parents.

Through various non-limiting aspects, the illustrative embodiments allow parents to report children playing at their house, track their own children's locations, request return, chat with other parents, identify playmates and generally manage their children in a manner that has very limited impact on a child's freedom. Parents can also be apprised of medical issues, dietary restrictions, curfews and other constraints, allowing some limited management of other families' children without having to keep a long list of ongoing and changing factors, or without having to have constant communication about the children playing at their house.

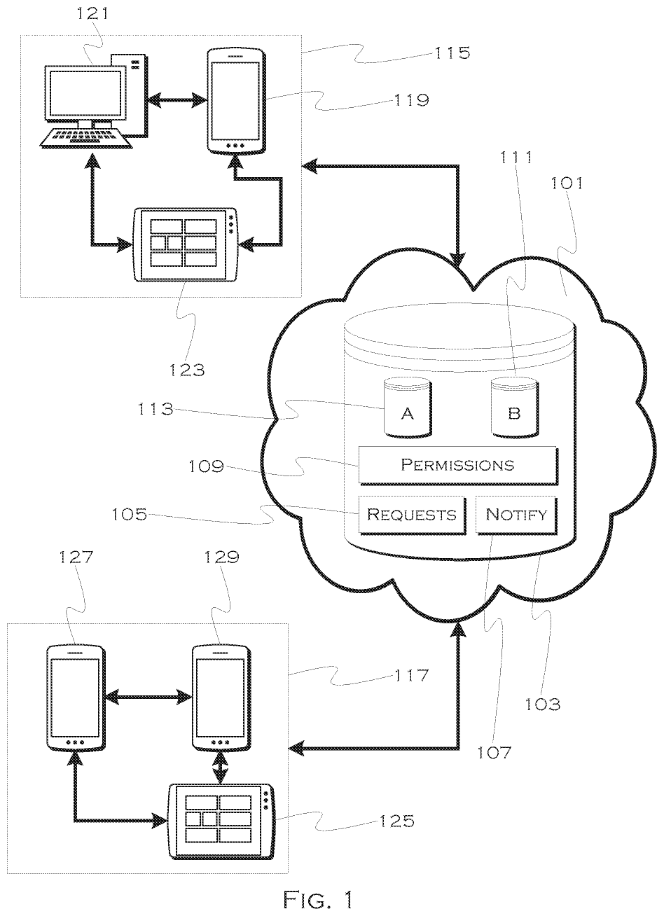

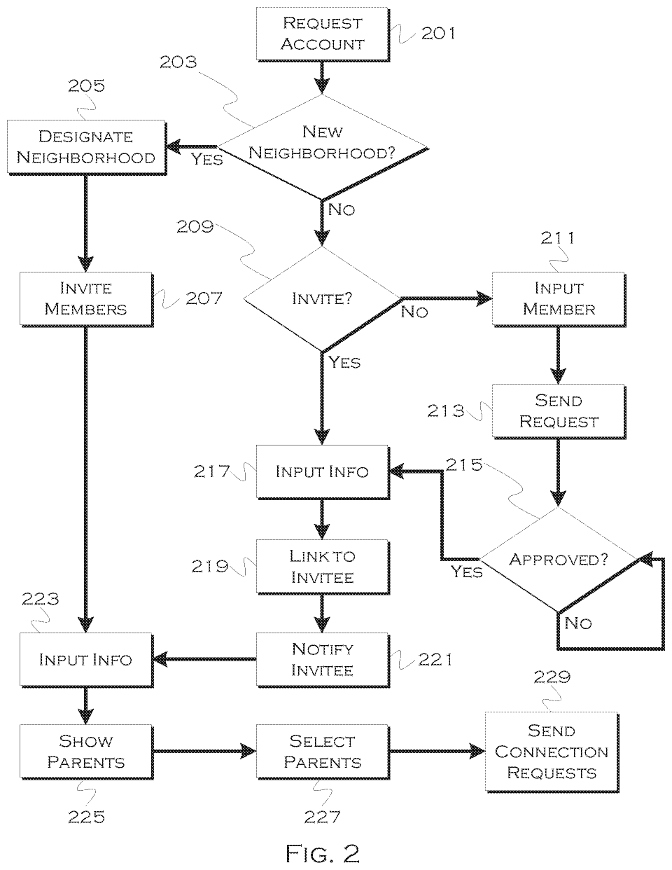

FIG. 1 shows an illustrative system for managing a set of neighborhood and play area groups. In this example, group A 115 may comprise a defined neighborhood, which can be defined by, for example, but not limited to, a geo-fence, a collection of homes, a set of bounding or inclusive addresses or streets, etc. The devices usable to interact with the cloud 101 can include PCs 121, tablets 123, wireless phones 119, etc. These devices may be enabled, through an application, for example, to communicate with both each other and to a remote cloud management system.

The cloud system 101 can include a database 103 which stores the information for hundreds of neighborhoods. This database can have smaller databases 111, 113 for each neighborhood, or can index member information in a variety of accessible, but protectable and protected, manners. Access and protection can be facilitated by a permissions 109 module, and notifications can be serviced by a notification module 107. Requests can be handled by a request 105 module, and these are just a few of the illustrative components of a comprehensive centralized management system.

Access can include, for example, requests to view one's own children, requests to view neighborhood and bulletin board information, tracking requests, curfew requests, notification requests, etc. Permissions may be limited to other members of a neighborhood or even to specifically identified other members. Some areas, such as a local park, may be accessible by a variety of members, but identification of who is currently at the park may be restricted to identification of direct friends or others in a predefined neighborhood to which the requestor belongs.

Notifications may be automatically generated in some cases, such as when a parent checks in a child and that child has a condition of which the parent should be aware (curfew, allergy, dietary constraint, etc.). Other notifications may be dynamically generated, responsive to a request, for example (e.g., curfew). Working together, the centralized management system can allow parents a comprehensive and complete set of tools for child management and oversight, with limited to no reliance on the child to do much of anything.

Area B 117 is an example of a park or other common area. Since children do not always stay within a single neighborhood, common areas may be publicly accessible to parents who add that areas to their sphere of interest. In other examples, the area may be automatically added by the presence of a child who is a neighborhood-member. That is, if the parent belongs to group A, the neighborhood, and that parent's child is reported as being at park B, or if the child has a device which self-reports, park B may be temporarily or permanently added to the parent's sphere of interest.

Within the park itself, various users may devices 125, 129, 127. This can include parent devices 127, caregiver devices 125 and child devices 129. Anyone who belongs to the same private neighborhood, for example, may be able to communicate with anyone else at the park, or the direct communication may be limited to parent and caregiver devices. The devices may also self-report (such as the child's device) when crossing a neighborhood, public location or other boundary. For children lacking devices, parents and caregivers can check those children in, allowing them to notify the child's parent that they saw the child at the park (in case the parent did not already know). Selecting a child for check-in is discussed herein, but this could include identification, by the local parent, of a child that was seen, and then an option to check-in which could be based on, among other things, whether or not the child was already checked-in at the park or public place.

In a similar manner, the process can check children into other neighborhoods to which the child does not belong. That is, even if the child is in a private neighborhood, to which the child does not belong, a parent may have direct personal connection with one or more parents in that neighborhood. In some cases, checking a child in at a location may attempt to establish such a connection, and at least public information (e.g., address) can be conveyed back to that child's parents. The parents of the child may have a limited ability to access some general neighborhood data and track their own child through the neighborhood, even though they are not members and do not have a direct presence or membership in the neighborhood. This can allow a child to move from one neighborhood to another, without the parent losing track of the child because the child left a predefined neighborhood. Put another way, while a parent may typically require an invitation or authentication to join a neighborhood, the reported or self-reported presence of a predefined child within a new neighborhood may grant some limited-access permissions to that child's parents, for at least the duration of the child's presence in the neighborhood.

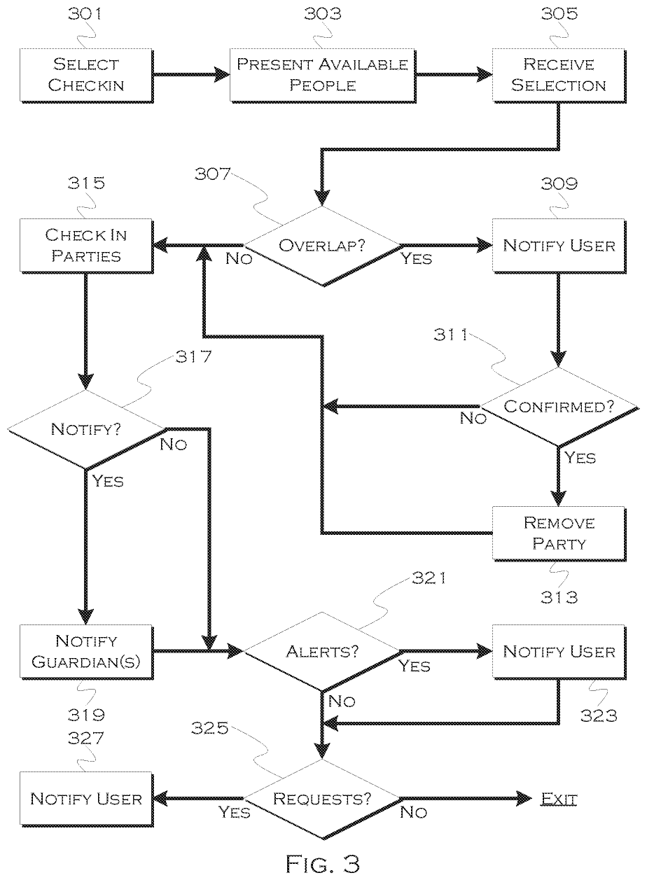

FIG. 2 shows an illustrative process for joining a neighborhood or group. In this example, a parent or caregiver/guardian (collectively referred to at least as “parents” herein) may either create a neighborhood or seek to join an existing neighborhood. The interested party requests 201 access to join a neighborhood.

If the access request includes a neighborhood creation 203 request, the process may request 205 definition of the neighborhood. Neighborhood definition can be as simple as naming the group, or as complex as designating geo-fence parameters around the neighborhood or a group of houses. This can also include use of addresses to limited the boundaries, geo-fencing around yards, and even selection of specific houses to include. When the neighborhood is merely named, the parent's house will define the neighborhood for the time-being, and as new members are added the neighborhood will expand to include those members. This allows for creation of a non-geographically bounded neighborhood (i.e., one that is defined by membership as opposed to geography) and may be more useful for keeping track of older, more mobile children.

For example, if a parent's definition of the “neighborhood” is “Sally's Study Buddies,” this neighborhood could be comprised of the group of children with whom Sally studies after school. While they will typically share some geographic similarity, they may not be co-located within the same traditional neighborhood, and thus a neighborhood in this sense can be somewhat decoupled from locality. This would allow a high-school child, with a car, to be tracked in a manner that ensured that the child was at a predesignated study location, for example, by allowing any parent of the group to report the presence of Sally at their house.

The process may also allow for invitation 207 of members when creating the group. Contacts can be identified by phone number (for text invitations), email address (for email invitations), etc. Selecting members for invitation may also flag whoever invited the member, for tracking purposes, if desired. Knowing who else is connected with a member and/or who invited the member may be useful for expanding groups, recommending invitees and for preventative measures to ensure that systems which are designed to be closed, remain so.

If the requestor is not creating a new neighborhood, they may be seeking to join an existing group or neighborhood. In the case of public groups (e.g., a park), they may simply be allowed to join, and a new profile can be created or the park can be added to a member's sphere of interest. To prevent unwanted members, the member may be required to be a member or participant of at least one private group, in order to join a public group, and/or the member may be restricted to viewing public group members who are not otherwise related through direct contact or a private group. These are just two examples of ways to restrict access if desired, although public groups can be controlled or constrained in any reasonable manner, if desired.

If the requestor (to the private group) does not have an invitation (or code, etc) 209, the process may allow them to specify 211 a known, existing member. The process can then send 213 a request to that member, which could be an email or even a verification text, whereby the member can respond with approval 215. Approval can be a simple yes or no, or a more complex verification of a relationship with the requestor, or can require that a more formal invitation be sent (via an automated process following approval, for example). If and when the requestor is approved 215, the requestor can input 217 their own personal and children information.

Sometimes a caregiver, such as a grandparent, may also identify children already belonging to another family. If a grandparent adds already existing children, approval can be requested from those children's existing parents. Location updates and the like can link to the children directly, so any person responsible for a given child can know the location and status of that child once approved. Other caregivers, daycares/babysitters, may have purview over a group of children, but no children of their own. These parties may be allowed to join and may be given time-constrained or use-constrained access to the information on children after parental approval, for any children for which the caregiver is responsible. In a similar manner, a parent can give a caregiver temporary rights to view the data relating to children for which the caregiver is responsible, but the caregiver may be restricted in access to viewing data on other children, even if the parent's account could see that data.

In some examples, if a member tries to join with a given address, and the address is already present, the member may be able to ask for permission to “join” the family listed at the address. This can allow caregivers to join an existing family without having to create an entirely new profile for that family. If the caregiver is an employee (i.e., babysitter), the access provided to that caregiver may be more limited than if the caregiver was a family member. For example, a grandparent may have full account access, but a babysitter may only have full access to the data relating to children assigned to that babysitter's care. Certain access permissions can be changed by an account manager and/or by parents of another account. For example, one parent may specify that their children are viewable by all members of “friend” accounts (including babysitters), which would give a friend's babysitter the same access the friend themselves had. Another parent may restrict levels of access for caregivers who are not direct members of the friend's family.

Once the parent has input their own personal and child data, which can include, for example, address, children information, allergies, alerts, medical conditions, curfews, etc., the parent can be linked 219 to the inviter. That is, a relationship can be created between the parent and the parent of another child, who invited the new parent. This can always be severed by either party, but will at least create a temporary ability to view limited information on the other party's children (e.g., a picture for identification purposes).

Neighborhoods may also include group permissions, defining what members and/or direct links can see about other children. If a neighborhood is very friendly, members may be able to see a reasonable amount of information about their child's friends. In other situations, simply a name (usable for check-in) may be all that is shown, and/or a loose description (e.g., brown hair, five feet tall) so the parent checking in the child may have limited assurance that they are checking in the correct child.

The process may also notify 221 the inviter, so the inviter knows that the invitee has joined and that the accounts have been linked. Another opportunity for information, such as identifying known or suggested friendships, can occur here 223. For example, if a parent identifies three other children as friends, and two are members and one is not, the process could invite the non-member (if contact information is provided).

For the member children (or really member parents), the process can show 225 either the identified parents and/or all parents in the neighborhood (by picture, name, address, etc). This can allow the new member to select 227 appropriate parents with whom a direct connection may be desired. The process can then send 229 direct connection requests to the identified parents. Such a schema may be used when there is a good reason to have both a neighborhood relationship and direct relationships, the direct relationships usually affording a larger set of optics for the associated parties with regards to each other's children and/or the parties themselves.

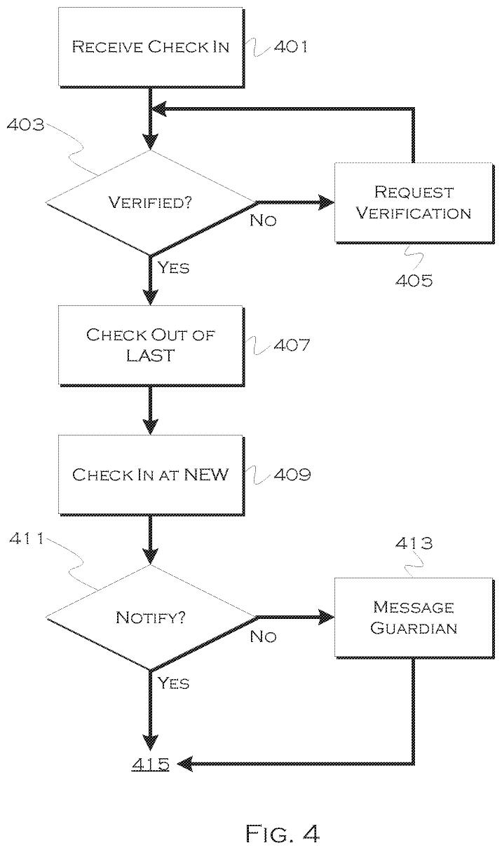

FIG. 3 shows an illustrative check-in process. In this example, a parent at a house will be checking-in one or more children present at that house. This can also approximate an illustrative procedure for checking in a child or group at a park or other public location.

When a parent sees a non-family child at their location, the parent can use an app or other similar format (e.g., a voice-activated smart device) to select 301 a check-in option allowing identification of children-present. Responsive to this selection, the process can present 303 (via an HMI or voice output) a list of available children. For example, a parent in neighborhood A can choose check-in and be shown a list of either friends of their children (direct relations) or neighborhood children, or a similar reasonable list of options. The parent can then select 305 the child or children who are at their house for check-in. Identification of the requestor can include a user-name, profile, device ID, application ID, given name, etc.

In some instances, Child X may be located at one house and move to another. Parents may not always realize this and/or check out a child, so the process may determine if there is any apparent overlap 307 in check-in (i.e., is Child X being check into a new, non-home location but still checked-in at another location). The process can notify 309 the old location, the parents and the new location of the overlap, and one or more of the parties (as deemed necessary) can confirm 311 that the child is at the new location (or no longer at the old location). If there is sufficient confirmation, the process can check-out 313 the child from the old location.

If there is insufficient confirmation, the process can still check-in the child at the new location, but may not check-out the child from the old location. The child-profile can show timestamped dual-locations, so a parent can still easily track down the child, but since parents are sometimes confused about identities, this redundancy still provides a reasonable assurance that at least there is some record of where the child is likely located.

The process can then check-in 315 all selected children, which can include, but is not limited to, creating a time-stamped record of where the child was checked in. This record can be accessed by any approved party, and should provide a reasonable record of where the child is located. A breadcrumb trail, by location, time, both, etc. can show a parent the activity of a child throughout the course of a day, week, month, etc.

Some children may have automatic notifications associated therewith, which can include, for example, notification upon check-in, notification upon check-in to certain houses, neighborhoods, public locations, etc. If any checked-in children include such requirements 217, the process may notify 319 the parents of those children based on the notification parameters and/or associated contact information.

Some children may also have automatic alerts, such as dietary or medical restrictions, associated therewith 321. For example, a child who has a peanut allergy or who is not supposed to be in the sun for an extended period of time. The process can notify 323 the parent checking in the children of any of these issues. Even if automatic check-in is enabled (e.g., without limitation, voice or facial recognition of present-children, biometric identification, device-based check-in via geofence or IP address of local network, etc.), the alert may be sent to the adult responsible for the household as identified by the profile associated with the household. This can help mitigate any potential damage from ignorance of a condition, and does not rely on the child knowing or conveying the condition. Notification can include, for example, sending a notification, generation of a notification, sending a notification signal, displaying a notification, etc.

Also, any requests associated with a child 325 may also be conveyed 327 to the responsible parent present. For example, a child may have a 6:30 curfew which is coming up or already past, and the parent can know that the child is supposed to go home. Similar requests may also be generated at any time, and conveyed to a party based on the child's known location(s). This can allow a parent to summon their child through another adult, which can diminish the chances of the child ignoring the request or overlooking it.

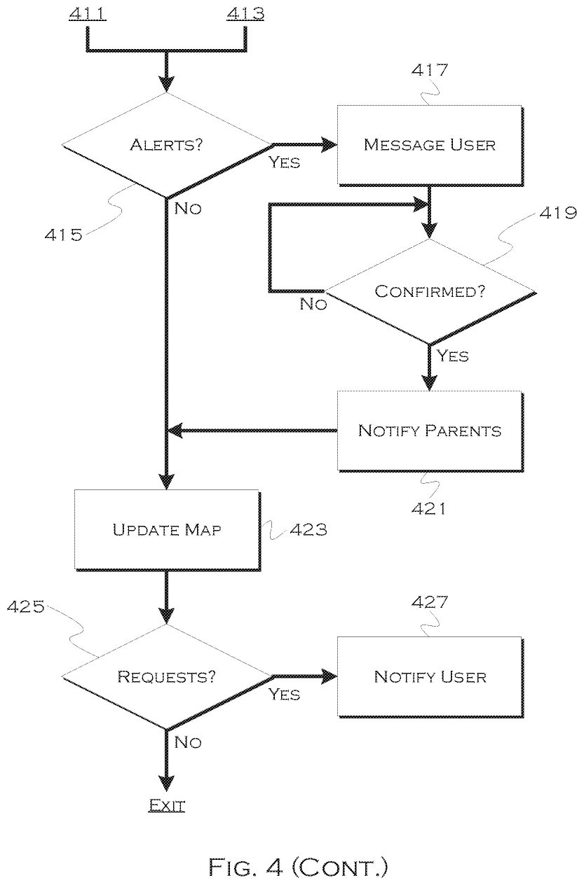

FIG. 4 shows an illustrative check-in completion process. In this example, the process receives 401 indication that a child is checked-in at a particular location. If there is a redundancy, or another reason why the child needs to be verified 403, the process can wait until the check-in is verified by the appropriate party(s).

If and when the child is checked-in and/or verified if needed, the process can then check the child out 407 of the last check-in location. This can help minimize confusion, and generally give parents a correct sense of where their child is currently located. The process also registers 409 the new location, checking the child in at the specified new location at a present time. Also, as previously noted, the process may require 411 notifications associated with some children, and so can generate 413 the appropriate parental notifications as needed based on check-in. Even children without ongoing notification may be given temporary requirement statuses, such as when a parent does not know where the child has been for a while, and so requests notification upon next check-in (to put their mind at ease).

Also, if there are any alerts associated with the checked-in child 415, the process may send a message 417 to the currently-responsible (homeowner) parent, and may even request confirmation 419. For life-threatening conditions, the child's parents may want to know that the message was sent and confirmed, to avoid or minimize the risk of medical incident. Once the message is confirmed 419 by the present-parent (if needed), the process can notify 421 the child's parents as well, so they know the alert was received and confirmed.

The process may also update 423 a map, if used/provided, showing a parent the child's new location. Each parent may be able to view a map or maps of member-neighborhoods showing, for example, all their children's present locations. They may also be able to, if permitted, view the location of other neighborhood children and/or direct-friend's children. The parent can also select (from their own profile), and or all of their children for request issuance 425. This can include a request to send a child home, a request to feed the child or make sure the child has water on a hot day, etc. Requests can be delivered 429 by the process to the responsible, present-parent as needed.

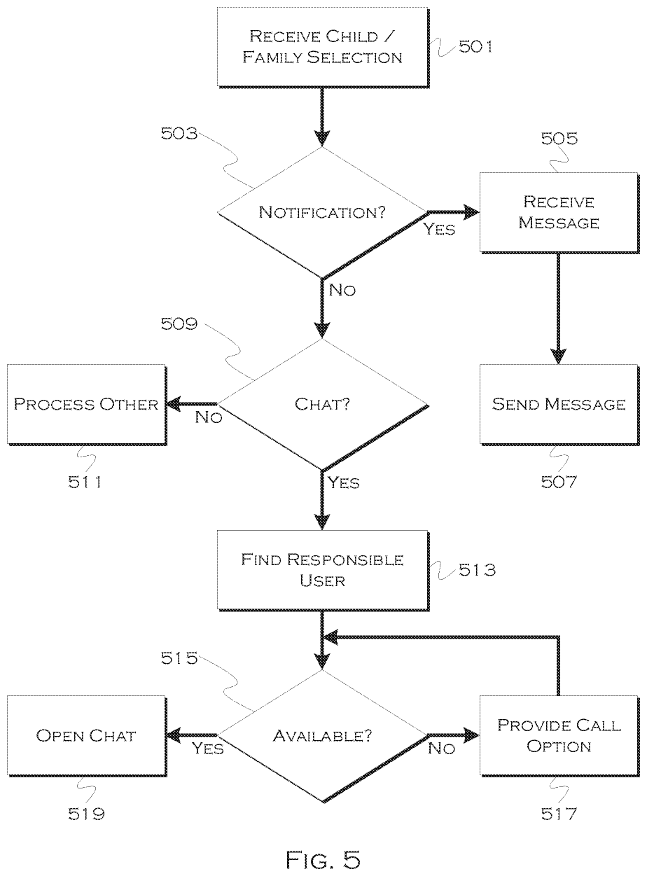

FIG. 5 shows an illustrative notification/communication process. In this example, the process allows a parent to communicate with their families and/or any present-parents (i.e., parents at a location where their child is located). The process includes a notification function which, if selected 503, allows the parent to craft and send a notification 505 that can be delivered 507 to both any present-parents and any child devices also part of the network.

In other examples, the parent may wish to engage in a chat 507 with a specific family member, present-parent or group of people. There may be tertiary communication requests as well, so the process can handle 511 those additionally.

If the chat option is selected, the process can create a direct communication group, using email, text, device to device messaging, etc. If the parent selects their children for the chat, they may really want to chat with the present-parent, and so unless the child has his/her own device, the process may determine 513 the present-parent for the child's location. Even if the child has a device, the present-parent may still be contacted for communication and chat purposes via specific selection. Parents can also select other parents directly, if they want to include others or know the identity of the present-parent.

If the present-parent (or other chat recipient) is available 515, the process may open a chat 519 function. If the person is not available, the process may place a call 517 (either number can be hidden if desired) to the parent, which can allow child's parent to leave a message or otherwise communicate with a party unable to chat. Since the system can hold all the numbers, communication can be established without having to share/know the phone numbers of everyone in the neighborhood.

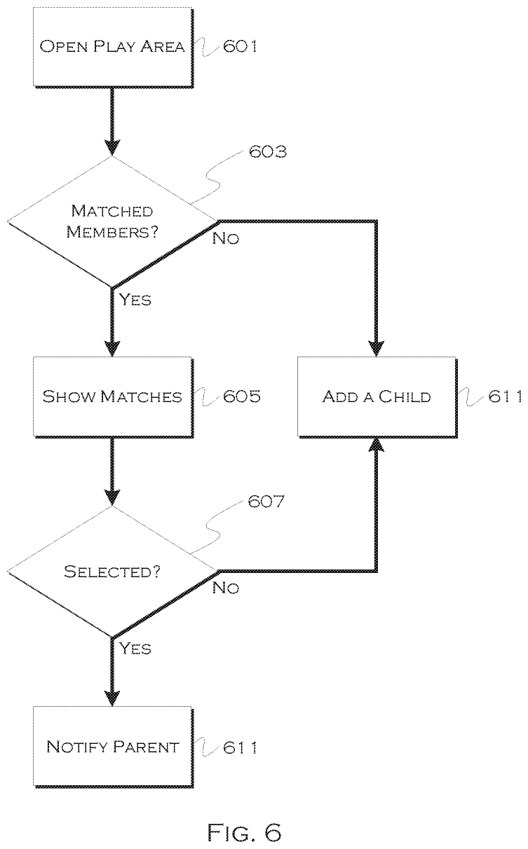

FIG. 6 shows an illustrative play-group connection process. In this example, the parent or guardian has a child who is not currently engaged in any activity. Instead of having to call all neighborhood friends, the process provides an easy format to announce availability, see who else is available to play, and connect interested children in a play-date. Similar processes can be used to identify babysitting, lawn mowing, snow removal and other services within a neighborhood or similar community, whereby one person either posts a need to a topic or selects a need-fulfiller already identified as part of an accessible group.

Here, the need would be for someone with whom to play, and the parent would open a corresponding “play” or “available” are within a site or application. This area can be limited to participation by neighborhood residents or other members of a group, and could, for example, be distinct from a neighborhood and instead tied directly to an account or even a child. That is, in one example, a parent could open a “play” area for their neighborhood with members from the neighborhood. In another example, the parent could open a “play” area which identified neighborhood and/or personal connection members available to play. In still a third example, the areas could be sorted by child, so if friendships between specified children existed, then selecting a given child for inclusion could first show you which of that child's friends (within the neighborhood or other groups) were currently also available.

If there are any matches 603 (e.g., other acceptable and/or predefined children with whom the child can play), the process can display the currently available children. Matching may not be automatic, as one child may be having a disagreement with another and may not want to play, or as one child may play too many video games and a parent may want a match with someone who is more likely to play outside that day. Parents can also selectively show/hide their listing from others, if desired, so as to attempt to avoid hurt feelings if one child's friends are available, but are not currently desired for play by that parent or child. If the parent selects 607 an available child, the process can notify the parent of the available child and request a play-date. If confirmed, the parents can call or chat, via the application if desired, in order to arrange details. In other examples, the request itself can propose details (e.g., “Hi, it's Sally's mother, would Tina like to come over to play from 3-4:30 PM?”. Much like a calendar function, organizing the invitation can include drop-down dates, times and a message attachment function.

If there are no matches currently available, the parent can add 611 the child to a list of available children, and then can wait for another friend to come online. The parent could be notified if any other children came online, if other friends came online, etc.

In one examples, parents can check family members into the play group and a notification may be sent to other members of the playgroup (whether or not they currently have checked-in children). Parents receiving the message can either just send a child over to play or can use the application to message the checked-in child's parent to set up a more formal arrangement. There may be a timestamp associated with the check-in, and in some examples checked-in children may be removed after a time limit, or if the child checks-in elsewhere (i.e., the child found a playmate), or if another child is checked-in at the playgroup child's house (indicating successful matching). Parents can also remove their children at any particular time, if desired.

What follows are some illustrative, non-limiting examples capturing aspects of the illustrative embodiments but not intended to limit the scope of the invention. Rather, this demonstrates examples of implementations of some of the illustrative embodiments and the like, to further understanding of the concepts.

During account creation, as noted, a person may elect to create a new neighborhood, may input an invitation code from another member, may have linked to creation through an invitation and/or may select a neighborhood from a displayed list of local neighborhoods. If a private neighborhood is selected, a passcode, invitation code or other verification may be required before the person can join the neighborhood. Creation of a neighborhood may also allow a creator to designate the neighborhood as public or private, as well as defining any access parameters.

In addition to the “play area” or “hangout,” where parents can find other neighborhood children available for play, similar bulletin boards may exist allowing for offering of services (e.g., yardwork or babysitting) and/or requests from neighbors (e.g., “can someone pick up my mail”). Viewing of postings may be neighborhood wide, may be filterable and/or may be restricted to viewing between trusted parties (e.g., the mail request may only be shown to designated direct contacts).

When a parent is checking in a child, they may be given options to see pictures of some already-connected children (where they have a direct connection with those children's parents, for example) and may simply see names of other children. Checking a child in at a house may generate a request for a direct connection, and real-time access updates can allow a parent, upon confirmation, to also see a picture of a child so that the child can be verified as the checked-in child.

When requesting direct connections, parents may see a list of local members for all neighborhoods, or simply local neighborhood members. By requesting a direct connection with a member in another neighborhood, in which the parent does not reside, the parent may be given limited access or full access to that neighborhood as well, following request-confirmation. At a minimum, the parent may be given access to see at least the data relating to that connection's house, for purposes of tracking children. Such access may also be limited to times when a child is actively checked-in in the given non-member neighborhood.

Each child may have a profile associated therewith, which can include, for example, without limitation, tracking history, historic places where the child was checked-in, a current location, and any medical, food or curfew predefined restraints for that child. These can be redefined as needed by a parent. The child profile may also include several hot buttons, such as, but not limited to, a “send home” request button, which sends a request to the responsible-parent and/or the child's device. Other options can include chat options (with the child or the responsible-parent) and any alerts currently associated with the child (e.g., child checked-out of location more than X minutes ago, no new location noted).

It will also be appreciated that check-in can be achieved through a variety of technological improvements, as well as manually by a responsible parent at the current location. For example, a video door-bell can include facial recognition data or access to neighborhood children, and may check-in children who ring the doorbell. It may be useful to have a limited database for such a purpose, whereby the doorbell only has to check a subset of a wider data set, based on children known to reside within a specific locality.

Another possibility is the recognition of a child's voice through a smart-home device. Again, a limited data-set could be used, for example, if the child has a smart-home device at home, and a voice-profile is known, that voice-profile can be shared with other friend-members who also have smart-home devices capable of voice recognition and profiling. Thus, if a child is “heard” by the smart-home device, the child can be confirmed and checked-in at the location without any affirmative action by the parent.

Check-in can also be automatically achieved by, for example, but not limited to, recognition of a local network/connection by a Wi-Fi/BLUETOOTH enabled device, a wireless device crossing a geo-fence, logon to a local network/connection by a device, etc. Responsible-parents can be given updates on who is currently and already checked-in, and manually check-in any remainder of children who were not automatically checked-in for any of a variety of reasons, when automatic check-in of some form is provided. Actual check-in devices, for the express purpose of checking-in, can also be provided. These can include biometric capabilities if desired.

The application may also work in conjunction with other safety related databases to increase child safety. For example, the application could scan a product label or barcode and provide food-allergy information or safety information for all checked-in children. This could be done by cross referencing known allergies with any elements of products known to trigger those allergies. In another example, the application could have access to a predator database, and alert parents if the child was checked-in within a certain proximity to a known predator or deviant.

The process can also include a localized Amber Alert, wherein a child that has not been seen in a certain time period results in issuance of a neighborhood alert. Once a parent in the neighborhood sees the child, they can use the alert to check-in the child and/or automatically contact the child's parents directly. Parents could also use this function to chat or report sightings, e.g. “well, I saw Sally over at Jenny's house 1 hour ago, but Jenny's family left 30 minutes ago.”

Any time a neighborhood member (child or parent) is referenced (such as Sally or Jenny above), their name may be hyperlinked and clickable to generate a direct contact link (phone, text, chat, etc) with the parents or guardians of the linked child. Parent names can be similarly hyperlinked, as can location names, if a message needs to be sent location-wide. For example, if Billy was last seen at Riverside Park, a parent could send a message to Riverside Park asking for a report on Billy. This message could go to people who know Billy, all members of a neighborhood at the park, all people at the park who were members of any neighborhood, etc. being able to broadcast a request to a location can assist in tracking down a child and may reduce the likelihood of lost children.

By providing a wide-spectrum, yet protected, suite of neighborhood services, the illustrative concepts and embodiments provide opportunities to improve the utility and functionality of child monitoring. Many of the aspects improve on traditional models, and parents are not left scrambling for solutions to commonly occurring child-watching scenarios. While all components are not necessary for any given solution, the individual components provide useful improvements for defining a custom neighborhood tracking and integration solution that is useful for many occasions. The novel, uncommon and atypical examples and concepts described herein demonstrate potential improvements achievable through use of those examples, concepts, and the like.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
a processor configured to:
receive a check-in request;
responsive to the request, determine a group to which a requestor, identified as having originated the request, belongs;
identify check-in candidates predesignated to the group;
receive selection of a check-in candidate; and
create an association between the check-in candidate and a requestor-location responsive to the selection.

2. The system of claim 1, wherein the processor is configured to determine the group based on the requestor-location.

3. The system of claim 2, wherein the requestor-location includes a home location, and the group is a neighborhood in which the home is located.

4. The system of claim 2, wherein the requestor-location includes a home location, and the group is a friend group of which the home has been designated as being a part of.

5. The system of claim 1, wherein the group includes a plurality of groups.

6. The system of claim 1, wherein the check-in candidates include children of other group members.

7. The system of claim 1, wherein the processor is configured to display pictures of the check-in candidates.

8. The system of claim 1, wherein the processor is configured to display names of the check-in candidates.

9. The system of claim 1, wherein the association includes a location-stamp and timestamp based on a time of request.

10. The system of claim 1, wherein the group includes an access-controlled private neighborhood group comprised of families including the check-in candidates within a predefined neighborhood.

11. The system of claim 1, wherein the processor is configured to display mixed information on check-in candidates, an information level varying based on a predefined relationship between a predesignated guardian of the check-in candidates and the requestor.

12. The system of claim 11, wherein the information is more detailed when a predefined direct relationship between the guardian and requestor exists, and less detailed when the predefined direct relationship does not exist.

13. The system of claim 1, wherein the processor is configured to provide the requestor with predefined alerts related to the selected check-in candidate, responsive to selection or creation.

14. The system of claim 13, wherein the alerts include food allergies of the check-in candidate.

15. The system of claim 13, wherein the alerts include medical conditions of the check-in candidate.

16. The system of claim 13, wherein the alerts include other safety-related warnings predesignated for the check-in candidate.

17. The system of claim 1, wherein the processor is further configured to provide the requestor with dynamic guardian requests following the creation, such that a request generated by a predesignated guardian of the selected check-in candidate is delivered to the requestor for at least a predefined period following the creation.

18. The system of claim 17, wherein the predefined period includes at least a period from creation until the selected check-in candidate is checked-out of the requestor-location.

19. A computer-implemented method comprising:
responsive to a check-in request, instructing creation of a time-stamped record of a child being located at a requestor-location, included with the request, notifying a requestor, who originated the request, of any predefined alerts associated with the child, and notifying a predefined guardian of the child of the requestor-location and time-stamp.

20. A computer-implemented method comprising:
responsive to a check-in request, identifying a list of children, predesignated as belonging to a group to which a guardian-requestor, who originated the request, is a member; and
responsive to selection of one or more of the children, creating an association between the selected children and a predefined guardian-requestor location, including notifying the guardian-requestor of any predefined alerts associated with any of the children and notifying predefined guardians of the selected children of the guardian-requestor location being associated with the respective selected children with whom individuals of the predefined guardians share a predefined relationship.
